(19) United States
(12) Patent Application Publication
(10) Pub. No.: US 2002/0161637 A1
(43) Pub. Date: Oct. 31, 2002

(54) Advertising system

(76) Inventor: Syunji Sugaya, Saga-shi (JP)

Correspondence Address: OSTROLENK FABER GERB & SOFFEN, 1180 AVENUE OF THE AMERICAS, NEW YORK, NY, 100368403

(21) Appl. No.: 10/018,510

(22) PCT Filed: Mar. 23, 2001
(86) PCT No.: PCT/JP01/02318

(30) Foreign Application Priority Data
Mar. 24, 2000 (JP) 2000-085164

(51) Int. Cl. G06F 17/60

(52) U.S. Cl. 705/14

(57) ABSTRACT

The invention is characterized in comprising: a network (1); a server connected to the network (30); and user side equipment (101) for presenting advertisements to a user while transferring data with the server via the network. Moreover, there is further provided a server (20) for delivering the advertisements to the user side equipment.

### TECHNICAL FIELD

The present invention relates to an advertisement presentation system for advertising to users who use a network (for example the Internet). In particular, it relates to a network advertisement presentation system that presents advertisements when users request delivery of target data.

### BACKGROUND ART

Heretofore, advertisement information systems on the Internet have used Internet advertisement methods such as banner advertisements, electronic mail advertisements, descriptive advertisements and the like.

A construction of a conventional advertisement information system on the Internet using the aforementioned banner advertisement is such that part of a web page is reserved as a space especially for advertisements as shown in FIG. 5, and an image is inserted into this space. In a case where this web page is, for example, a page for functioning as an Internet search engine or the like, an image file is displayed in the aforementioned space, and when this image is clicked a network containing the associated data is connected to the Internet, and it is possible to read content associated with this advertisement via the Internet.

An example of a conventional Internet advertisement information system for placing advertisements on pages on the Internet is disclosed in Japanese Patent Application, Unexamined Publication No. 10-102329. This conventional Internet advertisement information system provides advertisements and the like such that users of personal computers see them while requested pages are being loaded. These advertisements and the like may be in any form, one form of which is an animated advertisement. In a case of an animated advertisement, downloading can be performed in a shorter period of time than the time taken to display the advertisement itself. Between the point of time that an advertisement finishes being downloaded and the point of time that it finishes being displayed, the network is not used for delivery of advertisements or the like. Hence this network can be used to download the requested target page. Clearly, in a case where the network has a far higher speed than the source of the requested target page, such delays are not a major problem.

Furthermore, a conventional method of advertising on a personal computer wherein the Internet is not used will now be described based on FIG. 6. In the figure, an advertising method on a single personal computer is such that in a case where a user operates a keyboard 510 to make a computation control section 521 of a CPU 520 perform a predetermined computation operation, program software to perform this computation operation is read from an external memory 530, downloaded to internal memory 522 of the CPU 520, and an advertisement stored together with the software is displayed on a display section 540 during the download.

Since conventional advertisement information systems are constructed as above, while target data is being downloaded to a personal computer at the user side via the Internet no advertisement is displayed on the display section of the computer. Hence the time taken to download the target data cannot be utilized effectively. When targeting an advertisement to a user connected to the Internet, there is a problem in that it is not possible to provide an advertisement associated with the data or product (including services) that the user originally requested. Especially, since conventional advertisement information systems on the Internet uniformly present advertising content determined in advance, it is not possible to select suitable advertisements that can appeal to users at the point of time that the users request data delivery via the Internet.

### DISCLOSURE OF THE INVENTION

The present invention aims to solve the abovementioned problem with an object of providing an advertisement information system that can display advertisements that especially appeal to users by utilizing the time while target data delivered via a network is being downloaded.

To achieve the abovementioned object, a first aspect of the present invention is characterized in comprising: a network (1); a server connected to the network (30); and user side equipment (101) for presenting advertisements to a user while transferring data with the server via the network.

A second aspect of the present invention is characterized in that there is further provided a server (20) for delivering the advertisements to the user side equipment.

A third aspect of the present invention is characterized in that the user side equipment is provided with an animated advertisement reproduction section (steps 15, 26, 40, 56, 66 and 86) for reproducing the advertisements by animation.

A fourth aspect of the present invention is characterized in that there is provided a personal history information storage section (22, or steps 35, 55C and 65C) for storing personal history information regarding a user of the user side equipment.

A fifth aspect of the present invention is characterized in that there is provided a selection section (step 37) for selecting one or a plurality of advertisements to present to a user from among a plurality of advertisements based on the personal history information.

A sixth aspect of the present invention is characterized in that the personal history information contains the content or type of data transferred by the user, advertisements presented to the user, or the user's personal characteristics information.

A seventh aspect of the present invention is characterized in that there is provided a selection section for selecting one or a plurality of advertisements to present to the user from among a plurality of advertisements based on the environment of the user side equipment.

An eighth aspect of the present invention is characterized in that there is provided a data processing section (step 17) for executing or opening data transmitted to the user side equipment after an advertisement has finished being presented to the user, or when a predetermined setting is made by the user.

A ninth aspect of the present invention is characterized in that the user side equipment presents the advertisements to the user while downloading data from the server via the network.

A tenth aspect of the present invention is characterized in that the user side equipment downloads data and software required to use this data from the server via the network.

An eleventh aspect of the present invention is characterized in that the user side equipment presents the advertisements to the user while uploading data to the server via the network.

A twelfth aspect of the present invention is characterized in that there is further provided an input request section (steps 34, 55B and 65B) for requesting the user to input information interactively, and a response storage section (database 22 of advertisement side server or steps 35, 55C and 65C) for storing responses input by the input request section, when data is transferred between the server and the user side equipment via the network.

A thirteenth aspect of the present invention is characterized in that there is provided a response access section (CPU 21 of advertisement side server) for accessing responses stored in the response storage section.

A fourteenth aspect of the present invention is characterized in that there is provided a retrieval section (CPU 21 of advertisement side server) for retrieving responses stored in the response storage section.

A fifteenth aspect of the present invention is characterized in that there is provided a sales execution section (step 45) for executing sales of products or services to the user while data is transferred to or from the server via the network.

A sixteenth aspect of the present invention is characterized in that there is provided a processing section (step 76) for virus checking, defragmenting, or deleting unnecessary files from the user side equipment while data is transferred to or from the server via the network.

A seventeenth aspect of the present invention is characterized in that transfer speed is adjusted (steps 84 and 88) based on the state of presentation of the advertisement while data is transferred between the server and the user side equipment via the network.

An eighteenth aspect of the present invention is characterized in that data transfer finishes at the same time as or after presentation of the advertisement is completed.

That is to say, in an advertisement information system on a network according to the present invention, in a case where a user requests delivery of target data from a data server via the network, while delivering the related target data to the user side or downloading the related target data to be delivered to the user's storage device, an advertisement provided by an advertisement server is delivered to the user side, and the delivered advertisement is presented to the user.

In this manner, in the present invention, while downloading target data from a data server on request from a user to deliver the target data, an advertisement is delivered to the user's equipment from an advertisement server, and the equipment presents the advertisement. Hence it is possible to present the advertisement directly to the user by utilizing the time taken to download the target data.

A network advertisement information system according to the present invention, wherein there is a plurality of advertisements provided from an advertisement server, selects one or more advertisements to present to a user as required, based on the content or type of target data that is requested by the user for delivery, the user's personal identification data or the user's assignment.

In this manner, in the present invention, since a plurality of advertisements is prepared on an advertisement server, and suitable advertisements that can appeal to users are selected from this plurality of advertisements, it is possible to present effective advertisements that receive a high degree of attention by utilizing the time taken for download.

A network advertisement information system according to the present invention keeps a record of target data requested by the user and/or advertisements presented when the associated target data is requested as the associated user's history information in the data server or the advertisement server as required.

In this manner, in the present invention target data requested in the past by a user and advertisements presented in the past are stored as this user's history information, so that when a user requests fresh delivery of target data, a suitable advertisement can be selected for presentation based on the history information. Hence it is possible to further improve the effect of advertisements.

A network advertisement information system according to the present invention can read target data downloaded to the storage device of the user as required, conditional upon the presentation of the advertisement to the user being completed.

In this manner, in the present invention, target data is read by a user conditional upon the presentation of the advertisement to the user being completed, so that the advertising audience can be improved, enabling improvement of the effect of advertisements.

A network advertisement information system according to the present invention, wherein an advertisement to be presented to a user is formed by interactive steps comprising one or a plurality of questions, can read target data downloaded to the user's storage device as required, conditional upon one or more relevant questions being completed. In this manner, in the present invention, advertisements to be presented when delivery of target data is requested are comprised of a plurality of steps of interactive questions, and the target data is read conditional upon interaction with the questions being completed, so that the content of the advertisement can be acknowledged more fully by the user. As a result, the effects of advertisements can be improved, and also knowledge of products, services and the like in the advertisements can be increased.

By making this interactive style of advertisements into the form of a quiz with open competitions for prizes, the answers to these quizzes can be entered directly via the network.

A network advertisement information system according to the present invention, while presenting an advertisement to a user, executes sales of products or services associated with the advertisement as required. In this manner, in the present invention, since sales of products or services associated with the advertisement are executed while presenting the advertisement to the user, it is possible to improve the effect of the advertisement and also promote sales.

### BRIEF DESCRIPTION OF THE DRAWINGS

FIG. 1 is an overall schematic block diagram of an advertisement information system according to a first embodiment of the present invention.

FIG. 2 is an operation flow chart of the advertisement information system described in FIG. 1.

FIG. 3 is an operation flow chart of an advertisement information system according to a second embodiment of the present invention.

FIG. 4 is an operation flow chart of an advertisement information system according to a third embodiment of the present invention.

FIG. 5 is a display diagram of a conventional advertisement information system on the Internet using banners.

FIG. 6 is a block diagram of conventional advertisement execution for executing advertisements on a personal computer that does not use the Internet.

FIG. 7 is an operational flow chart of an advertisement information system according to a fifth embodiment of the present invention.

FIG. 8 is an operational flow chart of an advertisement information system according to a sixth embodiment of the present invention.

FIG. 9 is an overall schematic block diagram of an information presentation system according to a seventh embodiment of the present invention.

FIG. 10 is an operational flow chart of the information presentation system according to the seventh embodiment of the present invention.

FIG. 11 is a flow chart showing control by packet scheduling in the present invention.

### EMBODIMENTS

(First Embodiment of the Present Invention)

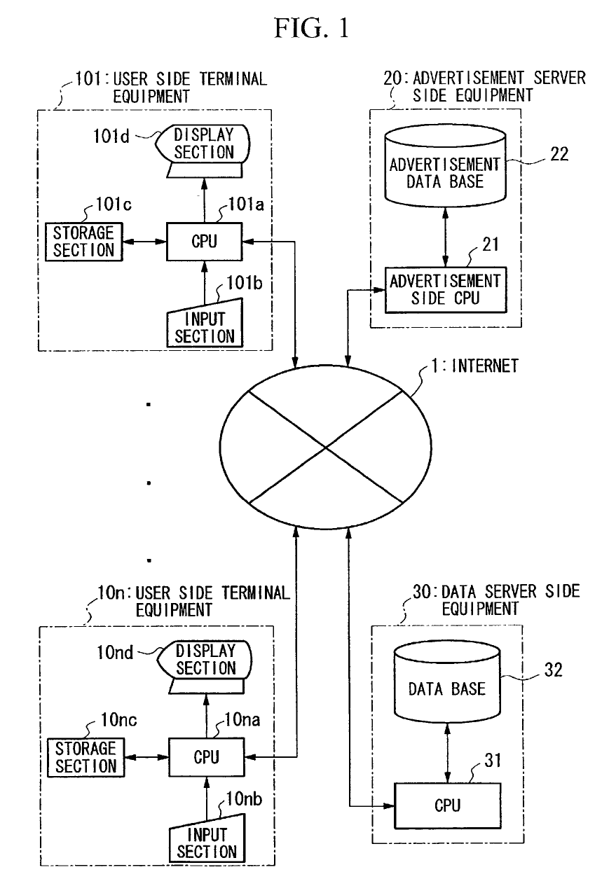

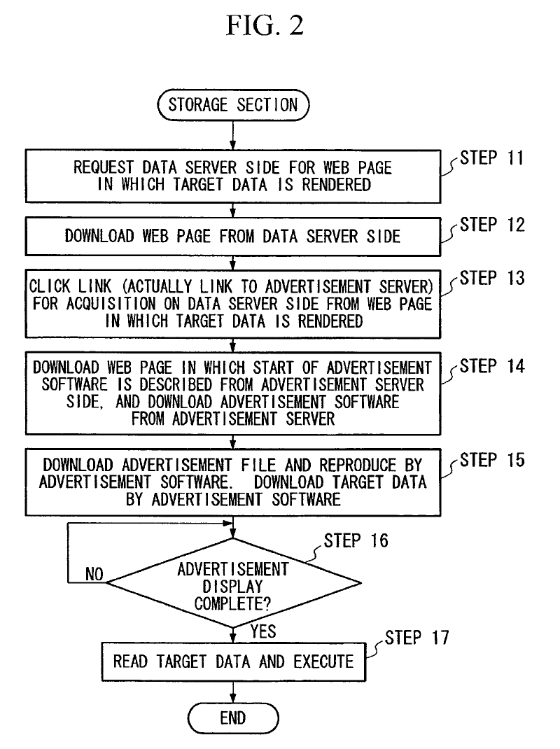

As follows is a description of an advertisement information system on a network, for example the Internet according to a first embodiment of the present invention, together with its method based on FIG. 1 and FIG. 2. FIG. 1 is an overall schematic block diagram of an Internet advertisement information system according to the present embodiment, and FIG. 2 is an operation flow chart of the Internet advertisement information system described in FIG. 1.

In the abovementioned figures, the Internet advertisement information system comprises: a plurality of user side terminal equipment 101 through 10n connected to the Internet 1; advertisement server side equipment 20, which is connected to the Internet 1, for delivering advertisements to the plurality of the user side terminal equipment 101 through 10n; and data server side equipment 30, which is connected to the Internet 1, for delivering software, a range of data (referred to hereunder as target data) and the like requested by users according to delivery requests from the plurality of user side terminal equipment 101 through 10n.

The advertisement server side equipment 20 comprises: an advertisement side CPU 21 for executing a range of processes associated with advertisement display operations when the plurality of user side terminal equipment 101 through 10n requests delivery of target data, and a storage section 22 for storing a range of advertising content as advertisement files as requested by advertisers, new personal information being added to the users'personal information registered in advance at each delivery request, storing this personal history information as history information files, and also storing advertisement software to control a range of processes associated with the advertisement display operation and advertisement files of advertisements executed by this advertisement software. The personal information contains personal characteristic information indicating a person's characteristics, which is an arbitrary combination of name, age, gender, address, occupation, family structure and the like, previous purchasing history information, advertisement access history information, advertisement question content information, reply history information for the questions and the like. Information other than this personal characteristic information is advertisement data base history information, wherein new information is written each time users request the delivery of target data from the plurality of user side terminal equipment 101 through 10n.

Next is a description of the advertisement display operation of an advertisement information system on the Internet based on the above-described construction. Firstly a user M1 connects user side terminal equipment 101 to the Internet, and uses a browser controlled by a CPU 101a on this user side terminal equipment 101 to request a web page which renders a target data base, from a data server side equipment 30 (step 11). By this request, the data server side equipment 30 delivers the web page and downloads it to a storage section 101c of the user side terminal equipment 101 (step 12).

The web page that is stored in this storage section 101c is displayed on a display section 101d, and a link to the target data rendered on this displayed web page is clicked (step 13). This target data link functions as a link to advertisement server side equipment 20.

By linking to this advertisement server side equipment 20, this advertisement server side equipment 20 delivers a web page in which the start of advertisement software is rendered, and downloads this advertisement software to the user side terminal equipment 101 (step 14). This user side terminal equipment 101 downloads an advertisement file, being advertising content, in which advertising content is described based on the downloaded advertisement software to the storage section 101c, displays this advertisement file on the display section 101d, and also downloads the target data from the data server side equipment 30 to the storage section 101c using this advertisement software (step 15).

It is judged whether display of the advertisement file is complete in the display section 101d (step 16). When judged that display is completed, the target data downloaded to the storage section 101c is read out, and the CPU 101a executes it or displays it on the display section 101d (step 17).

Furthermore, the arrangement may be such that if the user performs a predetermined operation during presentation of the advertisement, the target data is read out, and execution or display is performed. For example, the arrangement may be such that the target data is only executed or displayed in a case where the user has arranged in advance that downloaded target data be executed or displayed immediately, and in a case where such an arrangement has not made, the target data is only downloaded to storage and is not executed.

(Second Embodiment of the Present Invention)

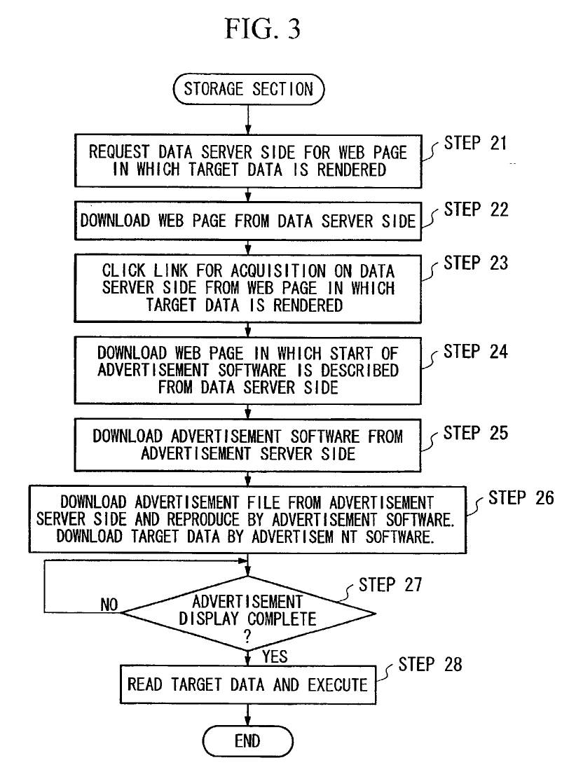

An advertisement information system on a network, for example on the Internet, according to a second embodiment of the present invention will be described together with its method based on FIG. 3, with reference to FIG. 1, except that the content of a web page that controls operations associated with advertisement display and the advertisement software control procedure are different.

Firstly, similarly to the software of the first embodiment, the user side terminal equipment 101 requests a web page in which target data is rendered from the data server side equipment 30 (step 21), and this data server side equipment 30 downloads it to a storage section 101c of the user side terminal equipment 101 (step 22).

The link to the web page that renders the target data is clicked from the downloaded web page (step 23), and a web page in which the start of advertisement software is rendered is downloaded from the data server side equipment 30 (step 24). By this request for delivery of the downloaded web page, the advertisement server side equipment 20 downloads advertisement software (step 25).

This user side terminal equipment 101 downloads the advertisement file being advertising content, in which advertising content is described based on the downloaded advertisement software, to the storage section 101c, displays this advertisement file on the display section 101d, and also downloads target data from the data server side equipment 30 to the storage section 101c using this advertisement software (step 26).

It is judged (step 27) whether display of the advertisement on the display section 101d by the advertisement file is completed. When judged that display is completed, the target data downloaded to the storage section 101c is read out, and the CPU 101a executes it or displays it on the display section 101d (step 28).

(Third Embodiment of the Present Invention)

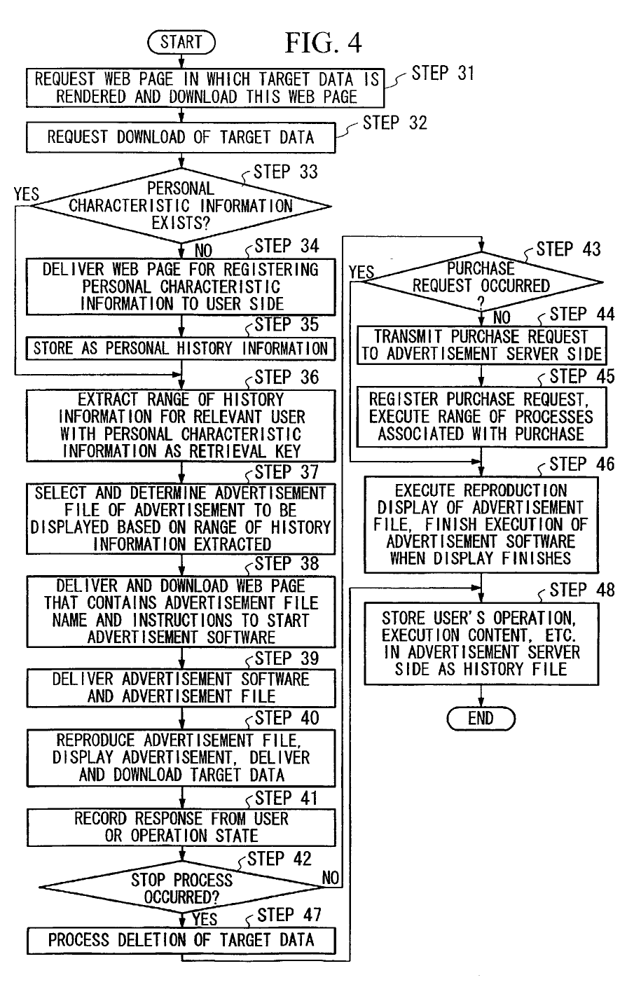

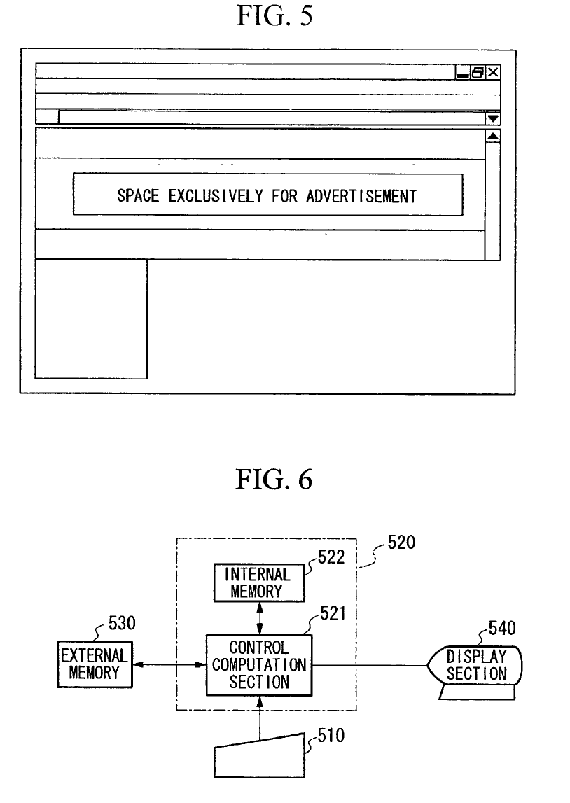

An advertisement information system on a network, for example on the Internet, according to a third embodiment of the present invention will be described together with its method based on FIG. 4, with reference to FIG. 1. This advertisement information system on the Internet according to the third embodiment has a similar hardware construction to the advertisement information system on the Internet according to the above-described first embodiment, except that the content of a web page that controls operation associated with advertisement display and the advertisement software control procedure are different.

Firstly, similarly to the system in the first embodiment, user side terminal equipment 101 requests a web page in which target data is rendered from data server side equipment, and this web page is downloaded to a storage section 101c of the user side terminal equipment 101 (step 31). This downloaded web page is displayed on a display section 101d, and a link to target data is clicked to request download of target data (step 32) from advertisement server side equipment 20.

This advertisement server side equipment 20 judges whether the aforementioned personal characteristic information (World Wide Web: corresponds to a cookie on the WWW), registered and stored in the user side terminal equipment 101 in advance, or freshly input personal characteristic information, exists (step 33). If judged that this personal characteristic information does not exist, the advertisement server side equipment 20 delivers a web page for registering personal characteristic information and a password to the user side terminal equipment 101 (step 34). When the user enters personal characteristic information such as name, age, gender, address, occupation, family structure and the like, and his password for registration, this registered personal characteristic information is stored in the storage section 22 of the advertisement server side equipment 20 as personal history information (step 35). Here, when this personal characteristic information is registered, this registered personal characteristic information is delivered to any one of a plurality of user side terminal equipment 101 through 10n from the advertisement server side equipment 20, and stored in the storage sections 101c through 10nc corresponding to the user side terminal equipment 101 through 10n respectively. Here, information to be registered may only be personal characteristic information.

Since personal characteristic information is stored in the user side equipment 101 through 10n, it is not necessary to input personal characteristic information again on second and subsequent occasions. Accordingly, when the user wants to purchase a product in step 46 to be mentioned later, the user can be determined based on the personal characteristic information stored in the user side equipment 101, and hence it is also possible to avoid the effort needed to input personal information required for the purchase.

Furthermore, at a second or later access, in a case where personal characteristic information stored in the user side equipment 101 through 10n is deleted, if the user inputs his password, this password is transmitted to the advertisement server side equipment 20 and recognition is performed. In the case where the password is correct, control proceeds to step 36. Accordingly, when the user wants to purchase a product in step 46 to be mentioned later, the user can be recognized only by inputting his password, and hence it is possible to avoid the effort needed to input personal information required for the purchase.

In this manner, when personal characteristic information is newly registered, or it is judged that personal characteristic information exists, with this personal characteristic information as a retrieval key, the advertisement server side equipment 20 extracts a range of history information such as past purchase history information, advertisement access history information, advertisement question content information, response history information and the like associated with this user from history information files stored in the storage section 22 of the advertisement server side equipment 20 (step 36).

Based on the range of history information extracted, the advertisement server side equipment 20 selects and determines an advertisement file to display to this user from a plurality of advertisement files stored in the storage section 22 (step 37). The advertisement file is selected depending on the environment of the user side terminal equipment (for example installed software, type of drivers). Furthermore, The advertisement file is selected depending on the user's personal information, for example the user's gender, age and the like. Moreover, the arrangement may be such that the user can select one advertisement to be displayed from a plurality of advertisement files.

Furthermore, this advertisement server side equipment 20 delivers the web page that contains the advertisement file name and instructions to start the advertisement software to the user side terminal equipment 101, and downloads it (step 38). Moreover, the advertisement server side equipment 20 delivers the advertisement software and the advertisement file to the user side terminal equipment 101, and downloads it (step 39). Here, the arrangement may be such that the advertisement software is installed in the user side terminal equipment 101 in advance, so that only the advertisement file is downloaded in step 39.

This user side terminal equipment 101 reproduces the advertisement file under control of the advertisement software downloaded using the starting instructions of the web page delivered, and displays it on the display section 101d. Furthermore data server side equipment 30 delivers and downloads the target data (step 40). The user's response to questions or the user's operating environment are stored by the reproduction display of this advertisement software (step 41).

Here, in step 40, the arrangement may be such that during downloading the target data, the advertisement software examines the system structure of the user side terminal equipment 101 and selects an advertisement file based on this system examination for display. Furthermore, the arrangement may be such that during downloading the target data in step 40, the advertisement software checks the license of the software installed in the user side terminal equipment 101.

The question style in step 41 may be for example, a user questionnaire. As an example, it may be a questionnaire about a product associated with the advertisement to be reproduced by the advertisement file. Responses to the questionnaire are stored as the user's responses or operating environment. In this manner, by utilizing the present advertisement system for a questionnaire survey, it is possible to perform market research and the like easily, and also it is possible to perform collection and collation of responses in a shorter time and with lower cost than a postal questionnaire survey. The responses to the questionnaires are transmitted to the advertisement server side equipment 20 in step 48 and stored in the storage section 22 as history files.

It is judged whether the user issued a stop command in the aforementioned step 40 during display reproduction by the advertisement software (step 42). In the case where it is judged that a stop command has not been issued, it is judged whether the user issued a purchase request for the product or services displayed by the advertisement software (step 43). In the case where it is judged that a purchase request has been issued, this purchasing request is transmitted to the advertisement server side equipment 20 (step 44). Based on this transmitted purchase request, the advertisement server side equipment 20 registers and executes a range of processes associated with the purchase (step 45).

In this manner, by executing a purchase operation during the advertisement display in a situation where a user's personal characteristic information is registered in advance, the user does not need to input his personal characteristic information separately in order to purchase, and hence it is possible to perform a simple and accurate purchase operation. Furthermore, since the advertisement server or the advertiser side can execute both advertisements and purchases at the same time, it is possible to judge the effect of the advertisement directly as well as promoting sales.

Furthermore in this purchase, in a case where the target data is CAD or CAM software or the like, the advertisement may be for equipment such as a printer or the like for use by this software, and the sales object may be equipment such as a printer and the like. Moreover, in a case where the target data is music software, the advertisement may be a performance of artists such as singers, musicians and the like of this music, and the object of purchase may be tickets for this performance.

After a range of processes associated with this purchase has been executed, or in the case where it is judged that a purchase request has not been issued in step 42, reproduction and display of the advertisement file by the advertisement software continues to be executed, and when this display operation is completed, download is confirmed to be completed and execution of the advertisement software finishes (step 46).

In the case where a stop process occurs while the advertisement file is being reproduced by the advertisement software in step 42, the CPU 101a executes a process such as deletion and the like set in advance of the aforementioned downloaded target data (or target data while being downloaded) (step 47).

After the advertisement software finishes in step 46, or the target data is processed in step 47, the details of the user's operations and actions are transmitted to the advertisement server side equipment 20, and this advertisement server side equipment 20 stores it as a history file in the storage section 22. The details of the user's operations may be transmitted immediately after downloading the target data, or may be transmitted by the advertisement software after a certain period has passed.

Here, in a case where the transmitted information contains responses to a questionnaire in step 46, the advertisement server side equipment 20 collates the responses.

Here, the advertiser can access personal characteristic information by accessing the advertisement server equipment 20. At this time, by searching by each item of; the advertisement file, time, personal characteristic information (gender, age, occupation, etc.), it is possible to access only the required personal characteristic information.

In a case where the history file contains users' responses to the questionnaire, the advertiser can access the collated results of the responses to the questionnaire by accessing the advertisement server side equipment 20. At this time, by searching by each item of; the advertisement file, time, personal characteristic information (gender, age, occupation, etc.), it is possible to access the required personal characteristic information.

(Fourth Embodiment of the Present Invention)

Here, in an advertisement information system on a network, for example on the Internet, according to the above-described embodiments, the construction is such that advertisements are presented by being displayed on a display section. However, it is also possible to present advertisements by voice or by printing them out.

Furthermore, in an advertisement information system on the Internet, according to the above-described embodiments, a case is described in which a plurality of user side terminal equipment 101 through 10n is connected to the Internet. However, the target data may be executed after the plurality of the user side terminal equipment 101 through 10n has been disconnected from the Internet. In this case, when executing or re-executing the target data, it is reproduced together with the advertisement file, and the advertisement operation can be executed for the user each time it is reproduced.

Especially, when the advertisement software (or advertisement soft) is downloaded to the plurality of user side terminal equipment 101 through 10n, a plurality of advertisement files is delivered, so that the plurality of advertisement files can be changed sequentially each time the target data is reproduced and re-executed. Furthermore, in a case where every one of the plurality of advertisement files has been reproduced, re-execution of the target data may be made impossible, or alternatively the plurality of advertisement files may be reproduced cyclically (or at random) again. The same also applies for the case where a plurality of user side terminal equipment 101 through 10n is connected to the Internet.

After every one of the plurality of advertisement files has been reproduced, in the case where re-execution of the target data is made to be impossible, the user must request delivery of the target data again in order to have the target data executed. When the delivery request is received from the user, only an advertisement file is downloaded from the advertisement server equipment. When the target data is re-executed, the advertisement file downloaded on the later occasion is reproduced. At this time, a plurality of advertisement files may be downloaded and changed sequentially for reproduction, or the same advertisement file may be reproduced repeatedly.

Furthermore, after the user has downloaded the target data, if the network is disconnected there is also a possibility that responses to the questionnaire and personal characteristic information cannot be transmitted to the advertisement server side equipment. In this case, that information may be uploaded to the advertisement side equipment 20 the next time the network is connected.

Moreover, in an advertisement information system on the Internet, according to the above-described embodiments, the construction is such that advertisement files are selected based on history information. However, it is also possible to predict future consumption tendency based on this history information, and present the predicted data to the advertiser as basic sales promotion data.

(Fifth Embodiment of the Present Invention)

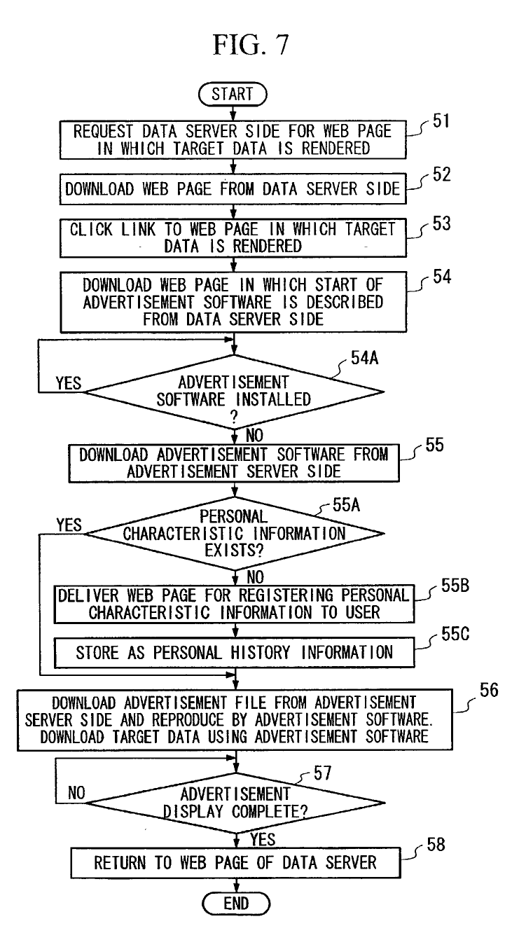

An advertisement information system on a network, for example on the Internet, according to a fifth embodiment of the present invention will be described together with its method based on FIG. 7, with reference to FIG. 1. This advertisement information system on the Internet according to the fifth embodiment has a similar hardware construction to the advertisement information system on the Internet according to the above-described first embodiment However, a point of difference is that in the first embodiment the advertisement software is downloaded from the advertisement server, while in the fifth embodiment, in a case where advertisement software for controlling operations associated with advertisement display is installed in the user side terminal equipment 101 in advance, the advertisement software is not downloaded.

Firstly, similarly to the software of the first embodiment, the user side terminal equipment 101 requests a web page in which target data is rendered from data server side equipment 30 (step 51), and this data server side equipment 30 downloads it to a storage section 101c of the user side terminal equipment 101 (step 52).

A link to the web page in which the target data is rendered is clicked from the downloaded web page (step 53), and a web page in which the start of advertisement software is described is downloaded from the data server side equipment 30 (step 54).

Here, it is judged whether advertisement software is installed in the user side terminal equipment 101 based on the description of the start of the advertisement software (step 54A). Here, if the advertisement software is not installed, the advertisement software is downloaded from the advertisement server side equipment 20 or the data server side equipment 30 when delivery is requested by this downloaded web page (step 55).

Alternatively, in step 54A, in the case where advertisement software is installed, control proceeds to step 56. That is to say, the user may download the advertisement software in advance from the advertisement server side equipment 20 or other servers, and install it in the user side terminal equipment 101. The advertisement software may be provided by other recording media such as a CD-ROM.

Next, this advertisement server side equipment 20 judges whether the aforementioned personal characteristic information (World Wide Web: corresponds to a cookie on the WWW), registered and stored in the user side terminal equipment 101 in advance, or freshly input personal characteristic information exists (step 55A). If judged that this personal characteristic information does not exist, the advertisement server side equipment 20 delivers a web page for registering personal characteristic information to the user side terminal equipment 101 (step 55B).

When the user enters his personal characteristic information such as name, age, gender, address, occupation, family structure and the like, and his password for registration, this registered personal characteristic information and password are stored in the storage section 22 of the advertisement server side equipment 20 as personal history information (step 55C). Here, when this personal characteristic information is registered, this registered personal characteristic information is delivered to any one of a plurality of user side terminal equipment 101 through 10n from the advertisement server side equipment 20, and stored in the storage sections 101c through 10nc corresponding to the user side terminal equipment 101 through 10n respectively.

Accordingly, since personal characteristic information is stored in the user side equipment 101 through 10n, it is not necessary to input personal characteristic information again on second and subsequent occasions. Here at a second or later access, in a case where personal characteristic information stored in the user side equipment 101 through 10n is deleted, if the user inputs his password then this password is transmitted to the advertisement server side equipment 20 and recognition is performed. In the case where the password is correct, control proceeds to step 56.

Next, the user side terminal equipment 101 downloads the advertisement file, being advertising content, in which advertising content is described based on the advertisement software to the storage section 101c, displays this advertisement file on the display section 101d, and also downloads the target data from the data server side equipment 30 to the storage section 101c using this advertisement software (step 56). The advertisement file is reproduced while the target data is being downloaded. Furthermore, if required it is downloaded together with a file associated with the target data, for example software to use the target data. To be specific, the advertisement software examines the environment of the user side terminal equipment, determines the required software depending on the type of the target data, and downloads it with the target data.

Moreover, in step 56, while the target data is being downloaded, the advertisement software performs virus checking of the user side terminal equipment 101. As a result, it is possible to perform virus checking automatically, and hence the user side equipment can be protected from viruses. Here, virus checking may not necessarily be performed. Furthermore, instead of virus checking, or together with virus checking, defragmenting and/or deleting unnecessary files may be performed.

The advertisement displayed on the display section 101d may be a static image based on the advertisement file. However, animation or sound may be used. An animated or audible advertisement would attract the attention of users, and hence the degree of permeation of the advertisement could be enhanced.

It is judged whether the abovementioned advertisement display by the advertisement file in the display section 101d is completed (step 57). In the case where it is judged that the display is completed, the user side terminal 101 accesses a web page on the data server side equipment 30 (step 58).

In this manner, in the fifth embodiment, in the case where advertisement software is installed in the user side terminal equipment 101, advertisement software is not downloaded, so that it is possible to shorten the time required for download.

Here, in the case where the advertisement display is completed in step 57, the arrangement may be such that the target data downloaded in the storage section 101c is read out, and the CPU 101a executes it or displays it on the display section 101d.

Furthermore, the advertisement file may be stored in the user side terminal equipment in advance, and when download of the target data starts this advertisement file may be reproduced. By storing the advertisement file in the user side terminal equipment in advance, it is possible to shorten the time required for download.

Moreover, a single piece of target data is downloaded in the present invention. However, a plurality of target data may be downloaded.

Furthermore, in the case where download of the target data is completed before reproduction of the advertisement file finishes, by utilizing the remaining time until reproduction of the advertisement file finishes, other data may be downloaded.

To be specific, while reproducing the advertisement file, the user side equipment displays the fact that download of the target data is completed, and informs the user that another file can be downloaded. The user, utilizing the remaining time of the advertisement display, can also download a program upgrade file or a trial version.

Moreover, while downloading the target data, not only reproduction of the advertisement file but also set-up operations by the user, for example rearrangement of mail, reset of time or the like may be performed. As a result, it is possible to utilize the time taken to download the target data effectively.

(Sixth Embodiment of the Present Invention)

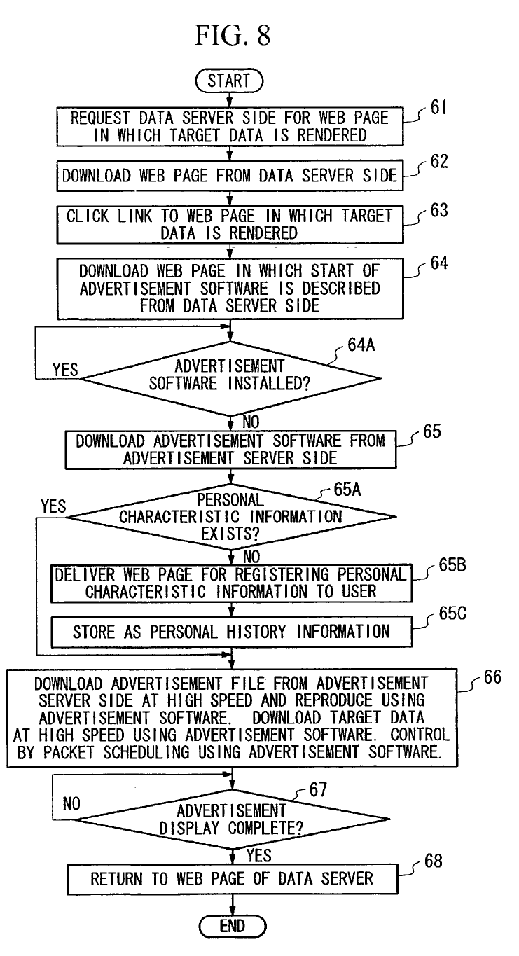

An advertisement information system on a network, for example on the Internet, according to a sixth embodiment of the present invention will be described together with its method based on FIG. 8, with reference to FIG. 1. This advertisement information system on the Internet according to the sixth embodiment has a similar hardware construction to the advertisement information system on the Internet according to the above-described fifth embodiment, and its method from step 61 through step 68 is almost the same as that in the fifth embodiment. However, a point of difference is that in the sixth embodiment, control is performed by high speed download and packet scheduling in step 66.

In step 66, the user side terminal equipment 101d ownloads an advertisement file at high speed, being advertising content in which advertising content is described based on the advertisement software, to the storage section 101c, displays this advertisement file on the display section 101d, and also downloads the target data from the data server side equipment 30 at high speed to the storage section lOlc using this advertisement software. Furthermore, the time taken to download and the time taken to reproduce the advertisement file are adjusted by control using packet scheduling (step 66).

Control by packet scheduling means to adjust the download speed of a plurality of files in order to achieve a specific purpose. In the present invention, it is to control the speed of downloading the advertisement file and the target data optimally to adjust to the reproduction status of the advertisement file. To be more specific, it adjusts the download speed such that when the target data is downloaded while reproducing the advertisement file, the reproduction of the advertisement file is not stopped, and also at the same time or after the reproduction of the advertisement file is completed, download of the target data is completed.

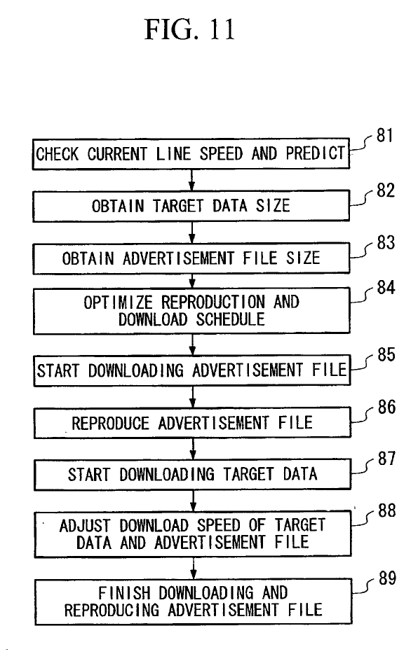

FIG. 11 shows a flow of the packet scheduling control according to the present invention.

As shown in FIG. 11, firstly the advertisement software obtains the data transfer speed of the applicable communication line, for example the highest speed, the lowest speed, average speed and the like (step 81). Next, the advertisement software obtains the file size of the target data (step 82) and also obtains the file size of the advertisement file (step 83).

Next, based on the transfer speed of the communication line, having obtained the file size of the target data and the file size of the advertisement file (step 82), reproduction of the advertisement file and download scheduling are performed. To be specific, from the file size of the advertisement file, the time required for this advertisement file to be reproduced up to the end is calculated, and download speed is determined based on this required reproduction time (step 84).

Next, download of the advertisement file starts at the assigned download speed for the advertisement file, which is determined in step 84 (step 85), and also the reproduction of this advertisement file starts (step 86). Here, in the present embodiment, the advertisement file is reproduced while downloading. However, the advertisement file may be reproduced after the download of the advertisement file is completed.

Furthermore, download of the target data starts at the download speed assigned to the target data, which is determined in step 84 (step 87).

Then, the advertisement software adjusts the download speed of the target data and the advertisement file while downloading (step 88). As a result, reproduction of the advertisement file is not stopped, and also download of the target data is adjusted such that it is completed at the same time or after the reproduction of the advertisement file is completed.

Then, download of the target data is completed (step 89) at the same time or after the reproduction of the advertisement file is completed (step 89).

In this manner, by controlling by packet scheduling, it is possible to reproduce the advertisement file through to the end, and hence the advertisement does not finish halfway. As a result, the user can hear and view the advertisement through to the end. Consequently, it is possible to provide an advertisement in a complete form, thus enabling the effect of the advertisement on a user to be enhanced.

Furthermore, for a method of displaying an advertisement to a user through to the end, the following method may be applied instead of packet scheduling control.

Firstly, the user side terminal equipment starts downloading target data, and also starts reproducing an advertisement file. At this time, the last part (for example 1 byte) of the file, being the target data, is not downloaded. Accordingly, even in a case where the download is completed before reproduction of the advertisement file is completed, the downloaded target data is not complete, and hence it is not possible to open this data nor execute it.

When reproduction of the advertisement file is completed, the user side terminal equipment receives a URL for where the last part of the file is stored, being the target data. Then, the user side terminal equipment accesses this URL, downloads the last part of the file that has not been downloaded, and links it to the previously downloaded data. In this manner, the target data becomes complete, and this target data can then be executed.

However, if the reproduction of the advertisement file is stopped by the user or by another reason, the downloaded target data remains incomplete, and also the URL for where the last part of the file is stored is not transmitted. Consequently the user cannot execute the target data.

That is to say, only in a case where the advertisement file is reproduced through to the end by the user side terminal equipment can the user obtain complete target data. Therefore the user can hear and view the advertisement through to the end. In this manner, the advertisement can be displayed in a complete form to the user, and hence it is possible to enhance the effect of the advertisement.

(Seventh Embodiment of the Present Invention)

Following is a description of an information presentation system on a network according to a seventh embodiment of the present invention.

This information presentation system is for application in, for example, an in-house network system, which is used for announcing in-house information to employees. Furthermore, it is used for informing users of useful educational material. It is not limited to in-house information and educational material, but may be used for providing users with a wide range of required information.

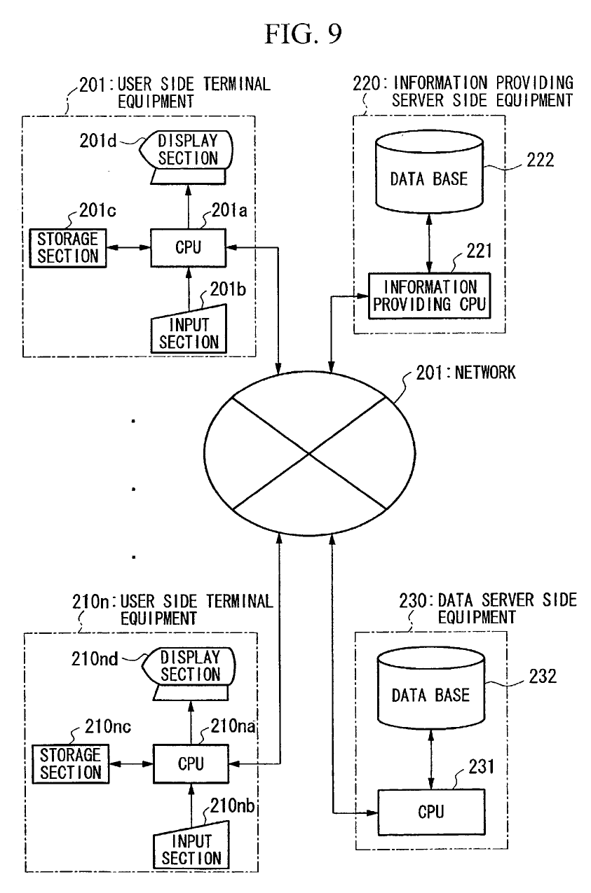

In FIG. 9, an Internet advertisement information system comprises: a plurality of user side terminal equipment 201 through 210n connected to a network 201; information providing server side equipment 220, which is connected to the network 201, for delivering advertisements to the plurality of user side terminal equipment 201 through 210n; and data server side equipment 230, which is connected to the Internet 1, for delivering software, a range of data (referred to hereunder as target data) and the like requested by users according to delivery requests from the plurality of user side terminal equipment 201 through 210n.

The advertisement server side equipment 20 comprises: an information providing side CPU 21 for executing a range of processes associated with information display performance when the plurality of user side terminal equipment 201 through 210n requests delivery of target data; and a data base 222 for storing a range of information content as information files as requested by information providers, new personal information being added to a user's personal information registered in advance at each delivery request, storing this personal history information as history information files, and also storing information display software to control a range of processes associated with the provided information display operation and information files to be executed by this information display software. The personal information contains personal characteristic information indicating a person's characteristics, which is an arbitrary combination of name, age, gender, address, occupation, family structure and the like, previous purchasing history information, advertisement access history information, advertisement question content information, reply history information for the questions and the like. Information other than this personal characteristic information becomes data base history information, wherein new information is written each time users request delivery of target data from the plurality of user side terminal equipment 201 through 210n.

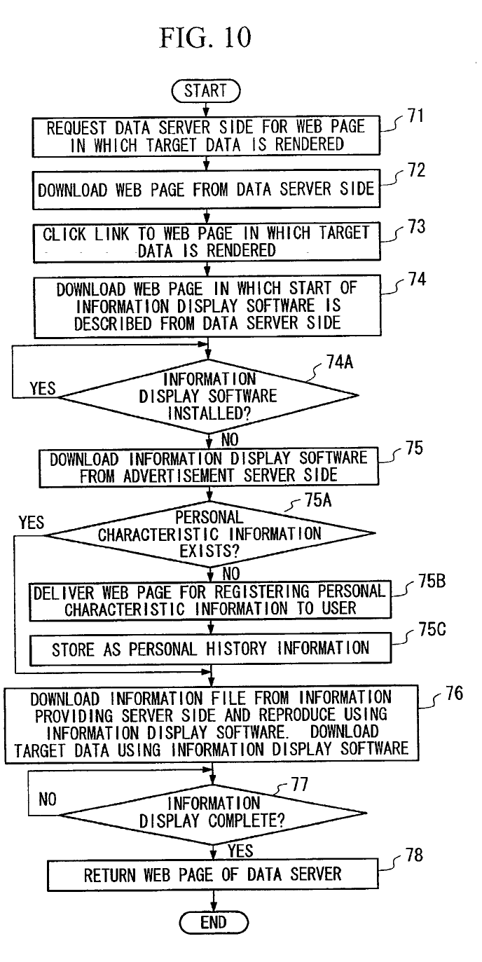

Next is a description of the operation of this information presentation system with reference to FIG. 10.

Firstly, user side terminal equipment 110 requests a web page in which target data is rendered from the data server side equipment 230 (step 71), and this data server side equipment 230 downloads it to a storage section 201c of the user side terminal equipment 230 (step 72).

A link to a web page in which the target data is rendered is clicked from the downloaded web page (step 73), and a web page in which the start of information display software is described is downloaded from the data server side equipment 230 (step 74).

Here, it is judged whether the information display software is installed in the user side terminal equipment 201 based on the description of the start of the information display software (step 74A). Here, if the information display software is not installed, the information display software is downloaded from the information providing server side equipment 220 or the data server side equipment 230 when delivery is requested by this downloaded web page (step 75).

Alternatively in step 74A, in the case where information display software is installed, control proceeds to step 76. That is to say, the user may download the information display software in advance from the information providing server side equipment 220 or other servers, and install it in the user side terminal equipment 201. The information providing software may be provided by other recording media such as a CD-ROM.

Next, this information providing server side equipment 220 judges whether the aforementioned personal characteristic information (World Wide Web: corresponds to a cookie on the WWW), registered and stored in the user side terminal equipment 201 in advance, or freshly input personal characteristic information exists (step 75A). If judged that this personal characteristic information does not exist, the information providing server side equipment 220 delivers a web page for registering personal characteristic information to the user side terminal equipment 201 (step 75B).

When the user enters his personal characteristic information such as name, age, gender, address, occupation, family structure and the like, and his password for registration, this registered personal characteristic information and password are stored in the storage section 222 of the information providing server side equipment 220 as personal history information (step 75C). Here, when this personal characteristic information is registered, this registered personal characteristic information is delivered to any one of a plurality of user side terminal equipment 201 through 210n from the information providing server side equipment 220, and stored in the storage sections 201c through 210nc corresponding to the user side terminal equipment 201 through 210n respectively.

Accordingly, since personal characteristic information is stored in the user side equipment 201 through 210n, it is not necessary to input personal characteristic information again on second and subsequent occasions. Here at a second or later access, in a case where personal characteristic information stored in the user side equipment 201 through 210n is deleted, if the user inputs his password then this password is transmitted to the information providing server side equipment 220 and recognition is performed. In the case where the password is correct, control proceeds to step 76.

Next, the user side terminal equipment 201 downloads the information file, being information content, which is provided based on the information display software to the storage section 101c, displays this information file on the display section 201d, and also downloads the target data from the data server side equipment 230 to the storage section 201c using this information display software (step 76). The information file is reproduced while the target data is being downloaded. The data is transferred by high-speed download, as used in the sixth embodiment. Furthermore, the information display software also performs control by packet scheduling as used in the sixth embodiment.

Moreover, in step 76, while the target data is being downloaded, the information display software performs virus checking of the user side terminal equipment 201. As a result, it is possible to perform virus checking automatically, and hence an in-house network can be protected from viruses. Here, virus checking may not necessarily be performed. Furthermore, instead of virus checking, or together with virus checking, defragmenting and/or deleting unnecessary files may be performed.

The advertisement displayed on the display section 201d may be a static image based on the information file. However, animation or sound may be used. An animated or audible advertisement would attract the attention of users, and hence the degree of permeation of the advertisement could be enhanced.

It is judged whether the abovementioned advertisement display by the information file in the display section 201d is completed (step 77). In the case where it is judged that the display is completed, the user side terminal 201 accesses a web page on the data server side equipment 230 (step 78).

Here, in the case where the advertisement display is completed in step 77, the arrangement may be such that the target data downloaded in the storage section 201c is read out, and the CPU 201a executes it or displays it on the display section 201d.

Here, one option is to use the Internet 1 in the abovementioned embodiments. However the present invention is not limited to this, but includes any network, for example a LAN (local area network) or an intranet. Furthermore, it includes a peer to peer connection network on which connected computers communicate with each other without a dedicated special-purpose server. Moreover, some or all of the connections of user side terminal equipment, advertisement server side equipment, information providing server side equipment, and data server side equipment may be provided by systems such as USB, Bluetooth, serial connections, wireless connections or the like.

Furthermore, in the abovementioned embodiments, the arrangement may be such that a link is extended to a site other than a data server and an advertisement server, for example to a site having a search engine, and a user accesses the data server or the advertisement server by clicking a link to this associated site to perform advertisement presentation. Here, the advertisement to be displayed at this time may be related with the associated site.

Moreover, the above-described advertisement information system and information presentation system reproduce an advertisement file or an information file while downloading. However, the arrangement may be such that an advertisement file or an information file is reproduced while uploading the data. That is to say, regardless of whether downloading or uploading, it includes a method of reproducing an advertisement file while transferring data. Furthermore, it includes streaming type data transfer in which data is transferred such that when user side equipment displays a reproduced animation, the display has priority and the amount of data is reduced. Moreover, data transfer includes temporarily performing data buffering at the transmitting side such that when a large amount of data is transferred, it is divided into chunks for transfer as required for display.

Furthermore, user side terminal equipment, advertisement server side equipment, information providing server side terminals and data server side equipment include personal computers, mobile telephones, PDAs, network terminals installed at distributors, household electrical appliances connected to a network, car navigation systems, and the like.

### Industrial Applicability

In the present invention, when a data server downloads target data by request from a user to deliver target data, an advertisement server delivers an advertisement to the user's equipment, and this equipment presents the advertisement to the user, and hence there is an effect that the advertisement can be presented directly to the user by utilizing the time taken to download the target data.

Furthermore, in the present invention, since the advertisement server prepares a plurality of advertisements, and selects a suitable advertisement to appeal to the user from this plurality of advertisements for presentation, there is an effect that the time taken to download is utilized to enable effective advertisements that receive a high degree of attention.

Moreover, in the present invention, since target data that the user has requested in the past and advertisements presented in the past are stored as this user's history information, when the user requests delivery of fresh target data, it is possible to select an appropriate advertisement based on the history information for presentation. Therefore, there is an effect that the effect of advertisements can be improved.

Furthermore, in the present invention, since a user reads out target data conditional upon the presentation of the advertisement to the user being completed, it is possible to improve the advertisement audience rating. Therefore, there is an effect that the effect of advertisements can be improved.

Moreover, in the present invention, since an advertisement to be presented when delivery of target data is requested includes a plurality of steps of interactive questions, and the target data is read out conditional upon the interactive questions being completed, it is possible to have a user acknowledge the advertising content more accurately. Therefore, there are effects that the effect of advertisements can be enhanced, and knowledge of advertised products, services and the like can be improved.

By making the advertisement questions into a quiz style with open competitions for prizes or the like, it is possible to get quiz replies directly via the Internet.

Furthermore, in the present invention, when presenting an advertisement to a user, sales of associated products, services and the like may be performed. Therefore, there is an effect that it is possible to achieve improvement of the effects of advertisements and sales promotion.

1. An advertisement presentation system characterized in comprising:
a network;
a server connected to the network; and
user side equipment for presenting advertisements to a user while transferring data with said server via said network.

2. An advertisement presentation system according to claim 1, characterized in that there is further provided a server for delivering said advertisements to said user side equipment.

3. An advertisement presentation system according to claim 1, characterized in that said user side equipment is provided with an animated advertisement reproduction section for reproducing said advertisements by animation.

4. An advertisement presentation system according to claim 1, characterized in that there is provided a personal history information storage section for storing personal history information regarding a user of said user side equipment.

5. An advertisement presentation system according to claim 1, characterized in that there is provided a selection section for selecting one or a plurality of advertisements to present to the user from among a plurality of advertisements based on said personal history information.

6. An advertisement presentation system according to claim 4, characterized in that said personal history information contains the content or type of data transferred by the user, advertisements presented to the user, or the user's personal characteristics information.

7. An advertisement presentation system according to claim 1, characterized in that there is provided a selection section for selecting one or a plurality of advertisements to present to a user from among a plurality of advertisements based on the environment of said user side equipment.

8. An advertisement presentation system according to claim 1, characterized in that there is provided a data processing section for executing or opening data transmitted to said user side equipment after an advertisement has finished being presented to said user, or when a predetermined operation is performed by said user during advertisement presentation.

9. An advertisement presentation system according to claim 1, characterized in that said user side equipment presents the advertisements to the user while downloading data from said server via said network.

10. An advertisement presentation system according to claim 9, characterized in that said user side equipment downloads data and software required to use this data from said server via said network.

11. An advertisement presentation system according to claim 1, characterized in that said user side equipment presents the advertisements to the user while uploading data to said server via said network.

12. An advertisement presentation system according to claim 1, characterized in that there is further provided an input request section for requesting said user to input information interactively when data is transferred between said server and said user side equipment via said network, and a response storage section for storing responses input by said input request section.

13. An advertisement presentation system according to claim 12, characterized in that there is provided a response access section for accessing responses stored in said response storage section.

14. An advertisement presentation system according to claim 12, characterized in that there is provided a retrieval section for retrieving responses stored in said response storage section.

15. An advertisement presentation system according to claim 1, characterized in that there is provided a sales execution section for executing sales of products or services to said user while data is transferred to or from said server via said network.

16. An advertisement presentation system according to claim 1, characterized in that there is provided a processing section for virus checking, defragmenting, or deleting unnecessary files from said user side equipment while data is transferred to or from said server via said network.

17. An advertisement presentation system according to claim 1, characterized in that transfer speed is adjusted based on the state of presentation of said advertisement while data is transferred between said server and said user side equipment via said network.

18. An advertisement presentation system according to claim 17, characterized in that data transfer finishes at the same time as or after presentation of said advertisement is completed.

19. A program for presenting advertisements, for execution on a computer;
a step for transferring data to or from a server via a network, and
a step for presenting advertisements on said user side equipment to a user while transferring data.

20. A program according to claim 19, for executing a step for delivering said advertisements to said user side equipment.

21. An advertisement presentation system characterized in that in said program according to claim 19, said user side equipment is provided with an animated advertisement reproduction section for reproducing said advertisements by animation.

22. A program according to claim 19, for executing a step for storing personal history information regarding a user of said user side equipment.

23. A program according to claim 19, for executing a step for selecting one or a plurality of advertisements to present to the user from among a plurality of advertisements based on said personal history information.

24. A program according to claim 23, characterized in that said personal history information contains the content or type of data transferred by the user, advertisements presented to the user, or the user's personal characteristics information.

25. A program according to claim 19, characterized in that there is provided a step for selecting one or a plurality of advertisements to present to the user from among a plurality of advertisements based on the environment of said user side equipment.

26. A program according to claim 19, for executing a step for executing or opening data transmitted to said user side equipment after an advertisement has finished being presented to said user, or when a predetermined operation is performed by said user during advertisement presentation.

27. A program according to claim 19, for executing a step where said user side equipment presents the advertisements to the user while downloading data from said server via said network.

28. A program according to claim 27, characterized in that said user side equipment downloads data and software required to use this data from said server via said network.

29. A program according to claim 19, for executing a step where said user side equipment presents the advertisements to the user while uploading data to said server via said network.

30. A program according to claim 19, for executing;
a step for requesting said user to input information interactively when data is transferred between said server and said user side equipment via said network, and
a step for storing responses input by said input request section.

31. A program according to claim 30, for executing a step for accessing responses stored in said response storage section.

32. A program according to claim 30, for executing a step for retrieving responses stored in said response storage section.

33. A program according to claim 19, for executing a step for executing sales of products or services to said user while data is transferred to or from said server via said network.

34. A program according to claim 19, for executing a step for virus checking, defragmenting, or deleting unnecessary files from said user side equipment while data is transferred to or from said server via said network.

35. A program according to claim 19, for executing a step for adjusting transfer speed based on the state of presentation of said advertisement while data is transferred between said server and said user side equipment via said network.

36. A program according to claim 35, for executing a step for finishing data transfer at the same time as or after presentation of said advertisement is completed.

37. A method of presenting advertisements comprising;
a step for transferring data to or from a server via a network, and
a step for presenting advertisements on said user side equipment to a user while transferring data.

38. A method according to claim 37, including a step for delivering said Em advertisements to said user side equipment.

39. A method according to claim 37, including a step where said user side equipment reproduces said advertisements by animation.

40. A method according to claim 37, including a step for storing personal history information regarding a user of said user side equipment.

41. A method according to claim 37, including a step for selecting one or a plurality of advertisements to present to the user from among a plurality of advertisements based on said personal history information.

42. A method according to claim 41, characterized in that said personal history information contains the content or type of data transferred by the user, advertisements presented to the user, or the user's personal characteristics information.

43. A method according to claim 37, including a step for selecting one or a plurality of advertisements to present to a user from among a plurality of advertisements based on the environment of said user side equipment.

44. A method according to claim 37, including a step for executing or opening data transmitted to said user side equipment after an advertisement has finished being presented to said user, or when a predetermined operation is performed by said user during advertisement presentation.

45. A method according to claim 37, including a step where said user side equipment presents the advertisements to the user while downloading data from said server via said network.

46. A method according to claim 45, including a step where said user side equipment downloads data and software required to use this data from said server via said network.

47. A method according to claim 37, including a step where said user side equipment presents the advertisements to the user while uploading data to said server via said network.

48. A method according to claim 37 including;
a step for requesting said user to input information interactively when data is transferred between said server and said user side equipment via said network, and
a step for storing responses input by said input request section.

49. A method according to claim 48 including a step for accessing responses stored in said response storage section.

50. A method according to claim 48 including a step for retrieving responses stored in said response storage section.

51. A method according to claim 37 including a step for executing sales of products or services to said user while data is transferred to or from said server via said network.

52. A method according to claim 48 including a step for virus checking, defragmenting, or deleting unnecessary files from said user side equipment while data is transferred to or from said server via said network.

53. A method according to claim 37 including a step for adjusting transfer speed based on the state of presentation of said advertisement while data is transferred between said server and said user side equipment via said network.

54. A method according to claim 53 including a step for finishing data transfer at the same time as or after presentation of said advertisement is completed.
